(19) United States
(12) Patent Application Publication
(10) Pub. No.: US 2004/0151361 A1
(43) Pub. Date: Aug. 5, 2004

(54) Method and apparatus for testing the quality of reclaimable waste paper matter containing contaminants

(76) Inventors: Pierre Bedard, Charlesbourg (CA); Feng Ding, Sainte-Foy (CA); Philippe Gagne, St-Nicolas (CA); Claude Lejeune, Beauport (CA)

Correspondence Address: JEAN-CLAUDE BOUDREAU, CRIQ BUILDING, 8475, CHRISTOPHE-COLOMB, MONTREAL, QC, H2M 2N9, CA

(21) Appl. No.: 10/760,319

(22) Filed: Jan. 21, 2004

(30) Foreign Application Priority Data
Jan. 22, 2003 (CA) 2,416,966

(51) Int. Cl. G06K 9/00

(52) U.S. Cl. 382/141; 382/165; 382/168

(57) ABSTRACT

Method and apparatus for testing the quality of reclaimable waste paper matter containing contaminants such as brown cardboard or colored plastic bag fragments employ image data analysis techniques to provide quality indication data useful for establishing reclaimed pulp process parameters. Polychromatic light directed onto an inspected area the matter is sensed following reflection thereon to generate color image pixel data representing values of color components within a color space for pixels forming an image of the inspected area. The image data is processed by comparison with color classification data related to one or more contaminants, to identify the pixels likely to be associated with the presence of the contaminant in the inspected area. The classification color data is derived from statistical distribution through Bayesian estimation of a probability that each said pixel be associated with the presence of each contaminant. A selection of remaining image pixel data associated with pixels likely to be not associated with the contaminants is made, and luminance-related data are generated from the remaining image pixel data to provide an indication of the quality of the reclaimable waste paper matter.

### FIELD OF THE INVENTION

The present invention relates to the field of instrumentation for use in waste paper reclaiming and pulp and paper production processes, and more particularly to method and apparatus for testing the quality of waste paper reclaimable matter containing contaminants.

### BACKGROUND OF THE INVENTION

In the past years, significant efforts have been devoted to develop processes for the production of pulp and paper products aimed at reducing manufacturing costs while improving product quality. Quality control of raw materials entering in the production of pulp and paper products, particularly regarding wood chips used has been identified as a key factor in process optimization, such as discussed in U.S. Pat. No. 6,175,092 issued to the present assignee, which discloses a method and apparatus for classifying batches of wood chips according to light reflection characteristics to allow optimal use of dark wood chips in pulp an paper processes. Quality control of raw material is also an important concern in the context of pulp and paper production processes using reclaimable waste paper matter as starting material, such as gray and colored newsprint papers and illustrated-magazine papers, which are supplied by reclaiming facilities as a result of sorting operations consisting of separating reclaimable waste paper material from other contaminants such as corrugated cardboard, plastic, metal or glass materials. A typical sorting process consists of manually separating newsprint papers and magazine papers transported on a conveyor, while the operator discards contaminants through visual inspection, to form distinct bundles, which will be used in various proportion at the input of a reclaiming pulp production process according to specific requirements. Such manual sorting operation inevitably result in partial contaminant removal, the level of which depends on operator skills and other production factors such as raw material and contaminant nature, relative proportion thereof at the input of the sorting process as well as flow rate of the material during inspection. Such factors are at the origin of significant variability in the residual contaminant content of waste paper bundles, which may affect at various degrees the efficiency of the reclaiming pulp and paper process fed by such waste paper material. For example, adhesives contained in corrugated cardboard may form sticky particles in the pulp which may affect the quality of paper made therefrom. Moreover, plastic bag fragments tends to obstruct the sieves, adversely reducing pulp flow therethrough. Apart from these drawbacks, the presence of contaminants may render more difficult the task of assessing quality of the main paper-based components of the raw material, to set pulp production process parameters accordingly. One of the main quality criteria of waste paper material relates to the level of fading or yellowing which gradually alters the initial whiteness/gray level of the paper with time, which effect is accelerated by light exposition. The amount of bleaching chemical agent required by the pulp production process to obtain a desired whiteness/gray level in the paper is highly dependent on the level of fading characterizing the waste paper. Another criterion is related to the black/color ink content of the waste paper, which directly influence the q quantity of deinking chemical agent required by the process. Moreover, although the use of newsprint papers is generally more cost effective, clay contained in magazine paper contributes to increase pulp strength. Therefore, the ratio newsprint/magazine paper at the input of the pulp production process is another quality criteria governing pulp production process characterization. Considering these known criteria, waste paper quality assessment involving the measurement of reflectance characteristics has been proposed to assist process parameter setting.

U.S. Pat. No. 6,398,914 B1 issued Jun. 4, 2002 to Furumoto discloses a method and device for controlling a de-inking process involving spectral characteristic measurement of raw material containing reclaimable paper, the h measurement data being fed to the input of a neural network generating correction variables for controlling pre-processing operation on raw material as well as pulp and/or paper production steps. A spectrometer is used as the measurement device to register intensity levels of light as it is reflected on the raw material for the set of predetermined wavelengths. According to a first embodiment, the raw material is essentially constituted of woodchips while a second embodiment uses waste paper as raw material. The selection of predetermined wavelengths that are appropriate to the nature of the waste paper matter and specific contaminants contained therein may be a complex task implying inefficient trial and error experimentation which can not warrant successful results.

U.S. Pat. No. 6,369,882 B1 issued Apr. 9, 2002 to Bruner et al. discloses and apparatus and method for detecting the presence of white paper on a conveyor of a paper sorting system, involving fluorescent measurement as obtained through elimination of the ultra-violet range, combined with a reflectivity measurement within the visible portion of the electromagnetic spectrum. However, such approach being limited to the detection of plain white paper, it is not appropriate for generally assessing the quality of waste paper matter containing other types of paper material along with various kind of contaminants.

U.S. Pat. No. 6,187,145 B1 issued Feb. 13, 2001 to Furumoto et al. discloses an apparatus and method similar to those described in U.S. Pat. No. 6,398,914 discussed above, wherein the measuring area of the spectrometer is directed to waste paper matter after it has been reduced into a stock suspension as starting material for the paper production.

U.S. Pat. No. 5,841,671 issued on Nov. 24, 1998 to Furumoto also discloses a neural network-based apparatus for controlling a pulp deinking process according to a similar approach as described in U.S. Pat. No. 6,187,145 B1 discussed above, wherein spectral measurement expressed in the form of RGB image signals are fed to the neural network to estimate ratios of colored paper/white paper and magazine paper/print newspaper to generate a control process signal.

U.S. Pat. No. 5,542,542 issued Aug. 6, 1996 to Hoffmann et al. discloses a system and method for assessing the content of contaminant particles within stock pulp suspension, which contaminant may include light plastic material. The proposed method requires sample withdrawal from stock pulp during processing to perform separating and extracting operations using analytical techniques which do not involve spectral analysis of pulp matter.

U.S. Pat. No. 5,085,325 issued on Feb. 4, 1992 to Jones et al. discloses a color sorting system of objects, including a color video camera using RGB output signals associated with each image pixel that are fed to a look-up table having a binary output corresponding to either an acceptable class or a reject class. The set of binary values assigned to image pixels are then processed using a spatial filter, and objects are rejected only if they have a certain number of sequences of unacceptable colors. Such binary classification cannot be used in applications where more than two distinct classes of objects are involved.

U.S. Pat. No. 4,812,904 issued Mar. 14, 1989 to Maring et al. relates to a statistical color analysis process for performing comparison between reference and test samples for use in quality control applications wherein a color video camera is employed to generate RGB and W luminance signals for each pixel of a considered area on the reference sample, wherein an average pixel value of such an area is estimated along with a tolerance value expressed in terms of standard deviation, allowing to establish if a corresponding area of the tested sample may be associated with the color characterizing the reference sample.

U.S. Pat. No. 4,758,308 issued on Jul. 19, 1988 to Carr uses a system for monitoring contaminants in a paper pulp stream including a photodetector based device used to measure intensities of light transmitted through a sample. A microprocessor is programmed to count the number of particles as well as their size, without involving any spectral analysis.

A conventional approach to classify objects according to color into different categories is known as the thresholding technique, according to which minimum and/or maximum limit values for one or more color components defined in a three-dimensional color space such as RGB or HSL standard systems are set to delimit an area within the color space which includes substantially all color components of pixels characterizing a specific colored class. However, the thresholding approach presents an inherent limitation when a plurality a colored class that are closely distributed within the color space are considered, so that misclassification of pixels within the peripheral portion of a class may occurs.

Even if many prior methods and systems involving the measurement of reflectance characteristics to provide information on quality of waste paper to be fed to pulp production process, has proved to be useful to orientate process parameters setting, there is still a need for an improved, more reliable quality assessment method based on reflectance measurement characteristics.

### SUMMARY OF INVENTION

It is therefore an object of the present invention to provide an improved, reliable method and apparatus for testing the quality of reclaimable waste paper matter containing contaminants.

According to the above object, from a broad aspect of the present invention, there is provided a method for testing the quality of reclaimable waste paper matter containing contaminants. The method comprises the steps of: i) directing polychromatic light onto an inspected area of the matter; ii) sensing light reflected on the inspected matter to generate color image pixel data representing values of color components within a color space for pixels forming an image of the inspected area; iii) comparing the image pixel data with color classification data related to at least one the contaminants to identify the pixels likely to be associated with the presence of this contaminant in the inspected area; iv) selecting the remaining image pixel data likely to be not associated with said contaminant; and v) generating luminance-related data from the remaining image pixel data to provide an indication of the quality of the reclaimable waste paper matter.

According to the above object, from a further broad aspect of the invention, there is provided an apparatus for testing the quality of reclaimable waste paper matter containing contaminants. The apparatus comprises a polychromatic light source for illuminating an inspected area of the matter and an image sensor receiving light reflected on the inspected matter to generate color image pixel data representing values of color components within a color space for pixels forming an image of the inspected area. The apparatus further comprises data processor means for comparing the image pixel data with color classification data related to at least one of the contaminants to identify the pixels likely to be associated with the presence of this contaminant in the inspected area, for selecting the remaining image pixel data likely to be not associated with the contaminant and for generating luminance-related data from the remaining image pixel data to provide an indication of the quality of the reclaimable waste paper matter.

### BRIEF DESCRIPTION OF THE DRAWINGS

A preferred embodiment of the present invention will now be described in detail with reference to the accompanying drawings in which:

FIG. 1 is a partially cross-sectional side view of a preferred embodiment of an apparatus according to the invention, showing a conveyor transporting waste paper matter through an inspection station connected to a data processor unit shown in block diagram;

FIG. 2 is a partial cross-sectional end view along section line 2-2 of FIG. 1, showing the internal components of the inspecting station;

FIG. 3 is a graphical representation of a plurality of color classes associated with corresponding contaminants as expressed in one of a set of basic color components within Lab color space in term of classification probability, showing exemplary pixel coordinate values to be classified;

FIG. 4 is a process flow diagram showing the main steps performed for testing the quality of reclaimable waste paper matter containing contaminants according to the present invention;

FIG. 5 is graph showing average luminance values in the HSL color space for successive images experimentally obtained from a batch of waste paper matter tested for quality assessment using the apparatus and method of the invention provided with computer display; and

FIG. 6 is an exemplary waste paper image as produced on the computer display, which image corresponds to the last luminance measurement represented on the graph of FIG. 5.

### DETAILED DESCRIPTION OF THE PREFERRED EMBODIMENT

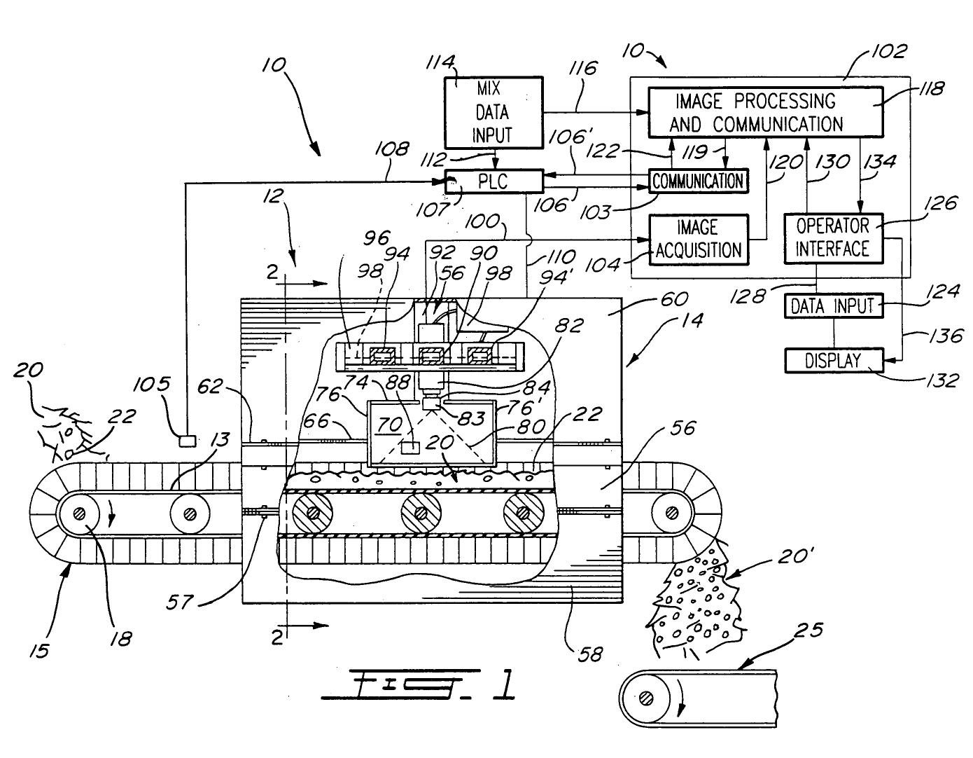

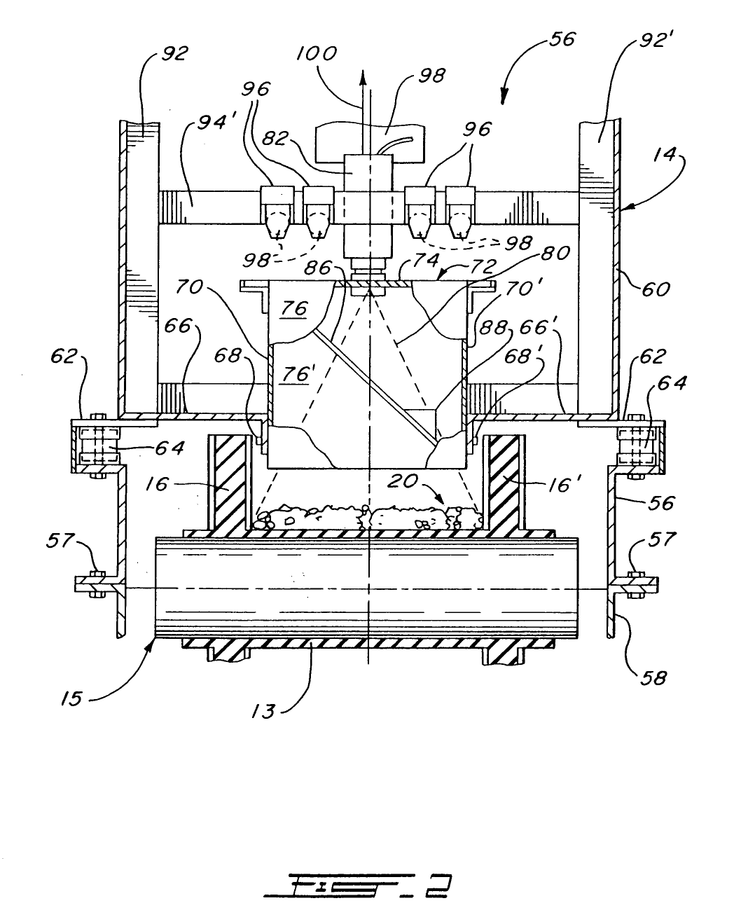

Referring now to FIG. 1, an apparatus according to the preferred embodiment of the present invention is generally designated at 10, which includes an inspection station 12 comprising an enclosure 14 through which extends a powered conveyor 15 coupled to a driving roll 18 which is itself couple to an electric motor (not shown) in a conventional manner. The conveyor 15 is preferably of a trough type having a belt 13 defining a pair of opposed lateral extensible guards 16 of a known design as better shown in FIG. 2, for keeping the matter to be inspected on the conveyor 15. Alternately, the inspection station 12 may be disposed over a conventional intermediate dumping or lifting ramp rather than over a horizontal conveyor. The conveyor 15 is adapted to receive at an input portion thereof reclaimable waste paper matter to be inspected, generally designated at 20, preferably in the form of batches coming from a conventional weighting conveyor (not shown) over which waste paper bundles have been manually or mechanically unwrapped. The waste paper matter, according to a preferred application, includes waste paper material such as newsprint paper and illustrated magazine paper blended with some contaminants represented at 22, such as corrugated cardboard and plastic fragments, which were not separated at a previous sorting operation. It is to be understood that waste paper material including other fibrous constituents such as used white or colored papers, blended with other contaminants (aluminum foil paper, waxed paper, metal can top) presenting particular spectral characteristics, may be advantageously tested in accordance with the present invention.

As shown in FIGS. 1 and 2, internal components of the inspection station 12 will now be described. The enclosure 14 is formed of a lower part 56 for containing the conveyor 15, rigidly secured to a base 58 with bolt assemblies 57, and an upper part 60 for containing the optical components of the station 12, being removably disposed on supporting flanges 62 rigidly secured to upper edge of the lower part 56 with bolted profile assemblies 64. At the folded ends of a pair of opposed inwardly extending flanged portions 66 and 66′ of the upper part 60 are secured through bolts 68 and 68′ side walls 70 and 70′ of a shield 72 further having top 74, front wall 76 and rear wall 76′ to optically isolate the field of view 80 of a camera 82 as part of an image sensor, for optically covering an inspected area of waste paper matter 20. The camera 82 is located over the shield 72 and has an objective 83 downwardly extending through an opening 84 provided on the shield top 74, as better shown in FIG. 1. Preferably, the distance separating camera objective 83 and the surface of waste paper matter is kept substantially constant by controlling the input flow of matter. Otherwise, the camera 82 may be provided with an auto-focus device as know in the art, preferably provided with distance measuring feature to normalize the captured image data considering the variation of the inspected area. A color video camera capable of generating standard RGB color image pixel signals, such as Hitachi model no. HVC20 is preferably used, as will be later explained later in more detail. Diagonally disposed within shield 72 is a transparent glass sheet 86 acting as a support for a calibrating reference support 88 as shown in FIG. 1, whose function will be explained later in more detail. A shown in FIG. 1, the camera 82 is secured according to an appropriate vertical alignment on a central transverse member 90 supported at opposed end thereof by a pair of opposed vertical frame members 92 and 92′ secured at lower ends thereof on flanged portions 66 and 66′ as shown in FIG. 1. Also supported on the vertical frame members 92 and 92′ are front and rear transverse members 94 and 94′. Transverse members 90, 94 and 94′ are adapted to receive elongate electrical light units 96 which use standard fluorescent tubes 98 in the example shown, employed as a polychromatic light source for illuminating the inspected area of the waste paper matter. The camera 82 and light units 96 are powered via a dual output electrical power supply unit 98. The camera 82 is used to sense light reflected on waste paper matter 20 and superficial contaminants 22 to generate color image pixel data representing values of color components within a RGB color space, for pixels forming an image of the inspected area, which color components are preferably transformed into color components within standard LAB color space for the purposes of a training operation as will be explained later in more detail. Electrical image signals are generated by the camera 82 through output line 100. When used in cold environment, the enclosure 14 is preferably provided with a heating unit (not shown) to maintain the inner temperature at a level ensuring normal operation of the camera 82.

Control and processing elements of the apparatus 10 will be now described with reference to FIG. 1. The apparatus 10 further comprises a computer unit 102 used as a data processor, which has an image acquisition module 104 coupled to line 100 for receiving color image pixel signals from camera 82, which module 104 could be any image data acquisition electronic board having capability to receive and process standard image signals such as model Meteor-2™ from Matrox Electronic Systems Ltd (Canada) or an other equivalent image data acquistion board currently available in the marketplace. The computer 102 is provided with an external communication unit 103 being coupled for bi-directional communication through lines 106 and 106′ to a conventional programmable logic controller (PLC) 107 for controlling operation of the conveyor drive 18 through lines 110, and for receiving through line 108 a control signal from presence sensor such as photocell 105 indicating whether waste paper matter is conveyer toward inspection station 12 or not. The PLC 107 receives from line 112 bundle mix data entered via an input device 114 by an operator in charge of mix of waste paper bundles at the dumping stage, as will be explained later in more detail. The input device 114 is connected through a further line 116 to an image processing and communication software module 118 outputting control data for PLC 107 through line 119 while receiving acquired image data and PLC data through lines 120 and 122, respectively. The image processing and communication module 118 receives input data from a computer data input device 124, such as a computer keyboard, through an operator interface software module 126 and lines 128 and 130, while generating image output data toward a display device 132 through operator interface module 126 and lines 134 and 136.

According to the invention, color classification data related to on or more contaminants likely to be present within the waste paper matter under inspection is previously stored in memory of computer 102, conveniently in the form of a look-up table that can be generated following a color classification training process applying a statistical classification approach, preferably based on a Bayesian classifier, as will be now explained in detail. While the method according to the invention may be use for testing the quality of waste paper matter blended with a single contaminant, for example fragments of domestic green trash bags, the use of a Bayesian classifier makes it particularly efficient to discriminate between a plurality of contaminants presenting distinct spectral reflectance characteristics, such as brown corrugated cardboard, orange or snow-white trash bag, etc. As explained in more detail by Fukunaga in “Introduction to statistical pattern recognition” Academic Press, 1990, a Bayesian classifier may be implemented by obtaining statistical distribution data representing values of color components within the chosen color space that characterize each contaminant, employing a training strategy wherein a set of samples for each class of contaminant is subjected to light inspection, so that the distribution of the color components values given by the color image pixel data may be calculated. Preferably, samples of non-contaminated waste paper material and contextual elements such as conveyor belt material, are also considered at the training step, to adjust classification parameters more accurately. Assuming that the resulting distributions characterizing all contaminant classes are substantially Gaussian, the classifier obtained as a result of the preliminary training process may then be used to estimate a probability that new pixel data be associated with any given color class that has been considered in the training step, each said class indicating the presence of a specific contaminant. In the general case involving a plurality of distinct classes of contaminants, classification color data is derived from the statistical distribution data through Bayesian estimation of a plurality of probability values that each pixel be associated with the presence of the contaminants, for then selecting the statistical distribution having the highest probably value, to identify a pixel as to be likely associated with the presence of the contaminant characterized by the selected statistical distribution. The probability that a given pixel of value x={r,g,b} or x={l, a, b} be associated with a color class ωᵢ within i=1,N (assuming that all classes are evenly probable) can be expressed as follows:

$$p ( x \vert {ω }_{i} ) = \frac{1}{\sqrt{2 π \vert {k}_{i} {Σ}_{i} \vert}} exp ( - \frac{1}{2} {( x - {μ }_{i} )}_{T} {( {k}_{i} {Σ}_{i} )}^{- 1} ( x - {μ }_{i} ) ) \qquad ( 1 )$$

wherein:

μᵢ is mean color component vector for color class ωᵢ;

Σᵢ is covariance matrix for color class ωᵢ; and

kᵢ is a scale parameter for color class ωᵢ.

It can be appreciated that the space area delimited by the envelope or shell defining each contaminant class may be either reduces of expanded by adjusting the value of scale parameter kᵢ as part of the training process, so as to either restrict or widen the selection of pixels for the color class considered. Typically, the value for scale parameter kᵢ can be selected within the ranges of 0<kᵢ<1 to restrict or kᵢ>1 to widen, depending on the outcome of the training process. Once the distribution for each contaminant color class has been established in the chosen color space, a probability threshold for each class is preferably defined and applied to validate if the estimated probability in the case of a single contaminant classification, or the highest probability value for the selected distribution in the case of multiple contaminants classification, is nevertheless sufficient to represent a reliable classification result. Hence, a given pixel defined by specific coordinates in the color space will be assigned to a candidate class only if the estimated or highest probability value for a given pixel is found to be greater than the predetermined probability threshold. Typically, the value for such probability threshold can be selected from 0% to 100% of the distribution's maximum peak, depending on the outcome of the training process.

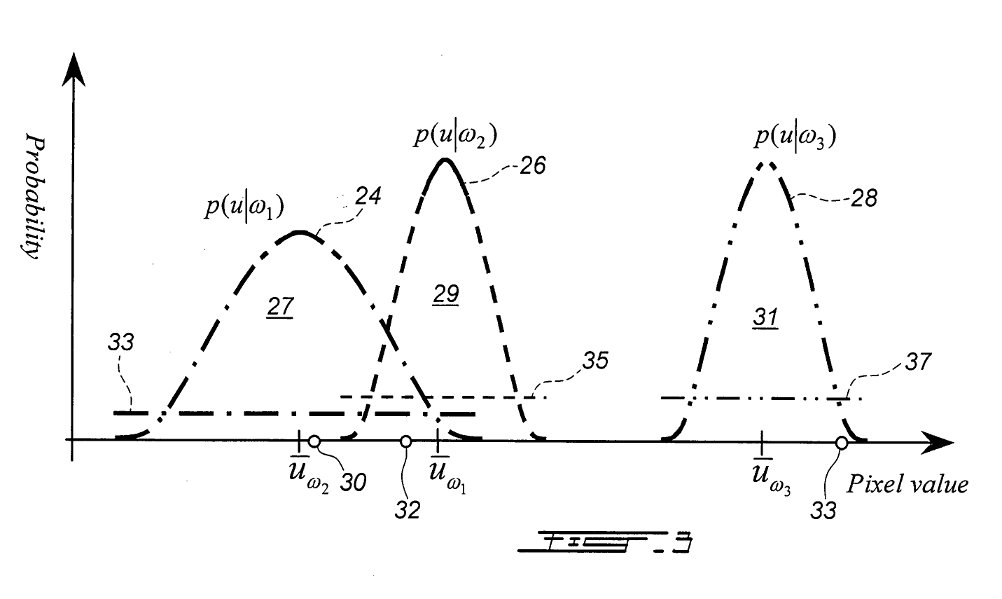

Referring to FIG. 3, an example involving three known contaminants to which are associated three color classes designated by ω₁, ω₂, ω₃ whose envelopes characterizing by maximum probability p<u|ω₁>, p<u|ω₂>, p<u|ω₃> at mean color component pixel values \overline{u_{ω}_{₁}}, \overline{u_{ω}_{₂}}, \overline{u_{ω}_{₃}} and generally designated at 24, 26, 28 delimit respective classification areas 27, 29, 31 within the selected color space, will be now discussed. Although a set of single color component curves is represented in FIG. 3 for the sake of clarity, three color components are preferably involved, which are defined within a corresponding three-dimensional color system. It can be seen that While the color components may be defined in standard RGB color space, LAB color components are preferably derived by the data processor unit 12 from RGB color data received from the camera 82, since they approximate the human eye color sensitivity and give somewhat better classification. It can be seen that to each class area 27, 29 and 31 is associated a corresponding minimum probability threshold represented by lines 33, 35 and 37 in FIG. 3. In the example shown, pixels 30 and 32 as expressed in basic LAB color components are respectively assigned to classes 24 and 26, while pixel 33 is excluded from the classification. According to the preferred validation step as explained above, pixel 33 was rejected since class 28 to which pixel 33 has the highest probability to belong, does not comply with the minimum probability threshold condition. The look-up table containing the color classification data is built by first registering at table input pixel coordinates data (RGB components values corresponding to the LAB components values calculated at the training operation) as well as associated class identification data as output data. Then, all remaining pixel coordinates data, up to the total number of about 16×10⁶ pixel coordinates, are registered at table input and associated with a general non-contaminant class at table output. The training and parameter setting software, as well as the look-up table based classification software may be readily programmed by any one skilled in the art of computer programming. Although a look-up table is preferably built in order to minimize the processing time required for the classification of the pixels in a complete image, which typically includes 76,800 pixels for a 320×240 image, it is to be understood that any other appropriate numerical or analytical technique for generating a classification result for any given pixel on the basis of the statistical distributions obtained through the training process, is contemplated to obtain color classification data according to the method of the invention.

Operation of the method and apparatus for the purpose of classification of reclaimable waste paper matter containing contaminants will now be explained in detail. Referring to FIG. 1, before starting operation of the apparatus 10, it must be initialized through the operator interface module 126 by setting the system configuration. Camera related parameters can be then set through the image processing and communication module 118, according to the camera specifications. The initialization is completed by camera and image processing calibration operations through the operator interface module 126.

System configuration provides initialization of parameters such as data storage allocation, image data rates, communication between computer unit 102 and PLC 107, data file management, contaminant identification classes and corresponding probability thresholds. As to data storage allocation, images and related data can be selectively stored on a local memory support or any shared memory device available on a network to which the computer unit 102 is connected. Directory structure is provided for software modules, system status message file, and classification outcomes data. Image rate data configuration allows to select total number of acquired images for a given batch of waste paper matter, number of images to be stored amongst the acquired images and acquisition rate, i.e. period of time between acquisition of two successive images which is typically of about 5 sec. for a conveying velocity of about 10 feet/min. Therefore, to limit computer memory requirements, while a high number of images must be acquired for statistical purposes, only a part of these images, particularly regarding low quality, rejected classification outcomes, need to be stored. The PLC configuration relates to parameters governing communication between computer unit 102 and PLC 107, such as master-slave protocol setting (ex. DDE), memory addresses for: a) batch data input synchronization for batch presence checking following waste paper bundle or batch dumping information; b) alarm set for indicating a low quality, rejected batch; and c) ((heart beat)) for indication of system interruption, ((heart beat)) rate and batch presence monitoring rate. Data file management configuration relates to parameters regarding bundle or batch input data, statistical data for inspected batches, data keeping period before deletion for quality acceptable batch and data keeping checking rate. Statistical data file can typically contain information relating to batch number, waste paper supplier contract number, waste paper mix content or grade, mean intensity values for Red, Green and Blue (RGB) signals, mean luminance L in LHS color space, date of acquisition, batch quality classification status (acceptable or rejected). The data being systematically updated on a cumulative basis, the statistical data file can be either deleted or recorded as desired by the operator to allow acquisition of new data.

In addition to classification results data to be obtained in a manner that will be explained later in detail, process parameters such as required quantities of bleaching agent and deinking agent, processing time or spent energy measured for prior inspected batches can be recorded to find out minimum threshold value associated with minimum processing yield required to qualify a batch as acceptable. As will be explained later in detail, reference threshold data delimiting two or more quality categories for the inspected waste paper matter can be predetermined and stored in computer memory. For example, acceptable and non-acceptable categories for an inspected batch may be respectively assigned to luminance-related data measured for waste paper batch above and below a predetermined minimum threshold. The image processing module 118 may also be programmed to allow the operator to set a maximum threshold above which an inspected batch could be considered more than acceptable, and therefore could be assigned a higher quality class. It is to be understood that specific values given to such classification thresholds could be dependent upon the system calibration performed. Once the camera 82 is being configured as specified, calibration of the camera and the image processing module 118 can be carried out by the operator through the operator interface 126, to ensure substantially stable light reflection intensities measurements as a function of time even with undesired lightning variation due to temperature variation and/or light source aging, and to account for spatial irregularities inherent to CCD's forming the camera sensors. Calibration procedure first consists of acquiring <<dark>> image signals while obstructing with a cap the objective of the camera 82 for the purpose of providing offset calibration, and acquiring <<lighting>> image signals with a gray target presenting uniform reflection characteristics being disposed within the inspecting area on the conveyer belt 13 for the purpose of providing spatial calibration. Calibration procedure then follows by acquiring image signals with an absolute reference color target, such as a color chart supplied by Macbeth Inc., to permanently obtain a same measured intensity for substantially identically colored wood chips, while providing appropriate RGB, LAB and/or HSL balance for reliable color reproduction. Initial calibration ends with acquiring image signals with a relative reference color target permanently disposed on the calibrating reference support 88, to provide an initial calibration setting which account for current optical condition under which the camera 82 is required to operate. Such initial calibration setting will be used to perform calibration update during operation, as will be later explained in more detail.

Initialization procedure being completed, the apparatus 10 is ready to operate, the computer unit 102 being in permanent communication with the PLC 107 to monitor the status of photocell 105 indicating the presence of a waste paper batch to be inspected. Whenever a new batch is detected, the following sequence of steps are performed: 1) end of PLC monitoring; 2) batch data file reading (type of waste paper, bundle mix for the batch, bundle or batch identification number); 3) image acquisition and processing for providing an indication of the quality of the waste paper matter; and 4) data and image recording after bundle or batch inspection. As part of the waste paper inspection process, light emitted form units 98 is directed onto an inspected area of the matter 20 as shown in FIG. 1. Image acquisition as performed by camera 82 and module 104 consists in sensing light reflected on the inspected matter to generate color image pixel data representing values of color components within a color space for pixels forming an image of the inspected area defined by camera filed of view 80. Although a single batch portion of superficial waste paper matter covered by camera field of view 80 may be considered to be representative of optical characteristics of a substantially homogeneous batch, waste paper matter being known to be generally heterogeneous, it is preferable to consider a plurality of batch portions by acquiring a plurality of corresponding image frames of pixel data. In that case, image acquisition step is repeatedly performed as the waste paper matter is continuously transported through the inspection area defined by the camera field of view 80. Calibration updating of the acquired pixel signals is performed considering pixel signals corresponding to the relative reference target as compared with the initial calibration setting, to account for any change affecting current optical condition.

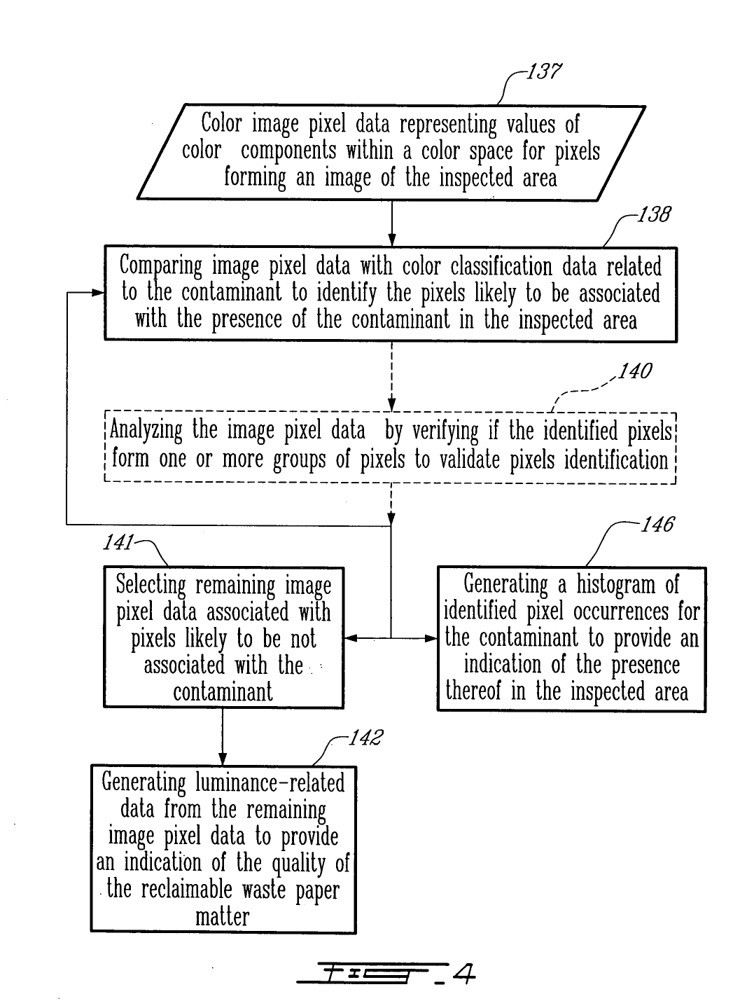

Referring to the process flow diagram of FIG. 4 in view of FIG. 1, in the context of a method for testing the quality of reclaimable waste paper matter containing a specific contaminant, for example brown corrugated cardboard, the image processing module 118 performs a comparing step 138 applied to color image pixel data designated at block 137 representing values of color components within the chosen color space for pixels forming an image of the currently inspected area of the waste paper matter, which image pixel data being generated by the image acquisition module 104. At step 138, the image pixel data is compared with the color classification data related to the cardboard to identify the pixels likely to be associated with the presence of such contaminant in the inspected area. As explained above, the color classification data is preferably stored in computer memory in the form of a look-up table generated on the basis of a learning operation during which samples of brown corrugated cardboard were presented at the inspection station. For each pixel of the input image, classification data is generated at the look-up table output, indicating whether the pixel is likely to be associated with the presence of brown cardboard or not. Then, an optional image pixel analyzing step 140 may be performed by the image processing module 118, which step consists of verifying if the pixels identified at step 138 form one or more groups including a sufficient number of pixels to validate pixels identification, such number being established experimentally at the training stage. Such optional operation may be advantageously performed to prevent misclassification as contaminant of pixels actually associated with paper material presenting similar spectral characteristics. For example, pixels representing brown ink pigments contained in the waste paper may be erroneously associated with the presence of brown cardboard. Since such color pigments are normally distributed within the waste paper matter, they generally correspond to isolated pixels that can be distinguished from group of pixels typically associated with a contaminant that is present within the Waste paper matter in the form of fragments. For so doing, morphological and grouping image analysis operations are performed on the image pixel data, regarding the pixels identified at prior step 138 as being likely to be associated with the presence of the contaminant, using known techniques such as black- and-white morphological opening followed by blob analysis. Pixel identification data generated either directly at step 138 or following validation at optional step 140 serve as input of a 1urther step 141, wherein remaining image pixel data associated with pixels likely to be not associated with the contaminant are selected according the programmed stored in image processing module memory. At following step 142, luminance-related data are generated from the remaining image pixel data to provide an indication of the quality of the reclaimable waste paper matter under inspection. Preferably, the luminance-related data is expressed within a continuous range of values that is effective to provide reliable indication about reclaiming pulp process parameters, and particularly about the optimal quantity of bleaching agent to add within the pulp according to the fading level or “yellowing” of the waste paper matter which reduces waste paper matter quality. In the case where the standard LHS color space is used, the luminance-related data are preferably obtained by averaging luminance-related image pixel data, basically expressed as a function of RGB color components as follows:

L=0.2125R+0.7154G+0.0721B (2)

Optionally, the image processing module 118 may be programmed to compare the average luminance-related data with reference threshold data as explained above, to provide a classification on the basis of quality indication, according to the following relation:

L>T_{L} (3)

wherein T_{L} represents a predetermined minimum threshold.

The value for threshold T_{L} may be experimentally set to delimit acceptable and non-acceptable categories of image pixel data, so that given average image pixel data are classified as acceptable if found above the minimum threshold, and classified as non-acceptable if found below the minimum threshold. It is to be understood that any other appropriate luminance parameter and threshold derived from basic color components such as RGB may be proposed. For example, luminance-related data may be derived by computing a ratio between the number of pixel signals representing values of either R, G or B above a predetermined minimum value and the total number of pixel signals considered. Optionally, standard deviation data may be derived from remaining image pixel data using well known statistical methods, variation of which pixel data may be monitored to detect any abnormal heterogeneity associated with an inspected batch of waste paper matter.

Whenever required, image noise due to visible conveyor belt areas can be filtered out of the image signals using known image processing techniques. Alternately, the color classification data may be generated at the training stage to include the color characteristics of the conveyor belt material, so as to exclude any belt imaging pixel from the analysis.

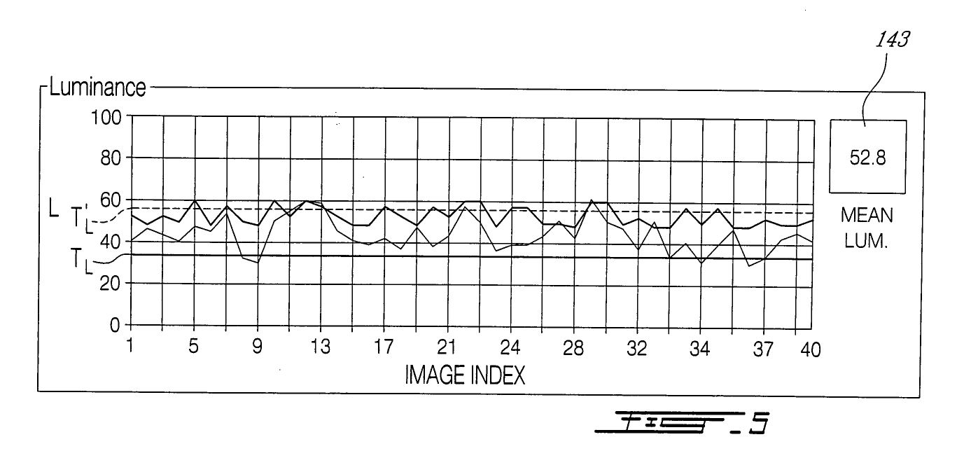

Referring now to FIG. 5, the exemplary graph shows average luminance-related component values in the HSL color space for 40 successive images experimentally obtained from a batch of waste paper matter tested for quality assessment using the apparatus and method of the invention. Although a single image frame may be analyzed at step 142 of FIG. 4 to obtain some quality indication, in order to provide testing results that are more representative of the quality of a whole inspected bundle or batch of waste paper matter, a plurality of image frame data, and consequently a plurality of adjacent areas of the surface of the matter are considered. For so doing, the image processing module 118 as shown in FIG. 1 first calculates an average luminance value from the luminance-related component values of remaining pixels as part of each image frame, and then calculates a mean luminance value for all successive image frames considered. For the example shown in FIG. 5, it can be appreciated that the calculated mean value L=52.8 as indicated at 143, is found greater than the predetermined minimum threshold T_{L}=34, and therefore, the quality of the corresponding batch of waste paper matter is classified as acceptable. However, if a predetermined threshold T_{L}=55 as indicated at 145 in dotted line were considered, the quality of the same batch of waste paper matter would be classified as non-acceptable. It can be seen from FIG. 4 that images of index=8,9,34 and 36 have been found to have a corresponding averabe luminance-related component value that is lower than the set minimum threshold value T_{L}=34. However, the resulting mean luminance-related value L=52.8 derived from the representative number of 40 currently diplayed images indicates the inspected batch is qualified as being of acceptable quality.

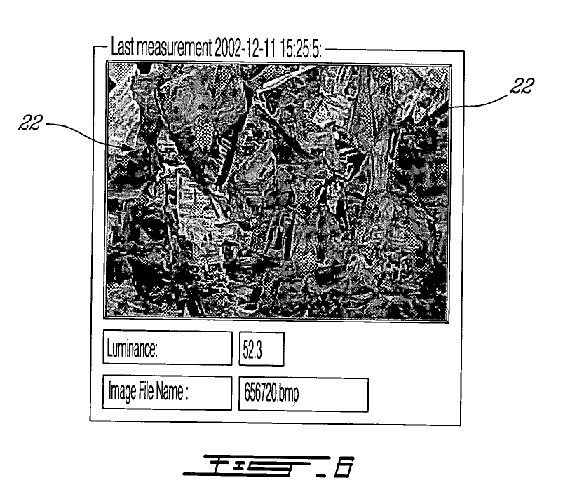

Referring now to FIG. 6, the waste paper image shown corresponds to the last luminance measurement represented on the graph of FIG. 5. Also displayed with the image is the estimated average value for the current image (L=52.3). It must be pointed out that pixels associated with the presence of contaminants within the waste paper matter, as indicated at 22, having been identified according to the method of the invention, only the remaining pixels were considered to test the quality of the waste paper matter.

Turning back to FIG. 4, in order to provide an indication of the relative level of contaminant detected in the inspected area, the image processing module 102 may further performs a step 146 according to which a histogram of identified pixel occurrences for the contaminant is generated to provide an indication of the presence thereof in the inspected area. Here again, a mean value based on a plurality of image frames, i.e. a plurality of corresponding histograms, may be calculated to obtain a more representative measure of relative contaminant level in a whole inspected bundle or batch of waste paper matter. For quality testing applications involving waste paper matter containing a plurality of contaminants, such as brown cardboard and plastic bags of various colors mixed with the reclaimable paper material, the same basic method as explained before are applied, wherein the image processing module performs step 138 by comparing the image pixel data with color classification data related to the selected contaminants, to identify the pixels likely to be associated with the presence of each of these contaminants in the inspected area. As explained above, the classification color data were previously derived through statistical training from color components values within the chosen color space that characterize the various contaminants. RGB color components data as part of the remaining image pixel data, may be used to derive information about coloration of waste paper matter mainly due to the presence of inks in newsprint or magazine papers, which information is useful for establishing deinking process parameter regarding the amount of deinking chemicals required.

Turning back to FIG. 1, whenever the inspected batch is classified as being acceptable, the computer unit 102 commands the PLC 107 to return in monitoring mode, waiting for a following batch to be inspected according to a control signal received from presence sensor 105, while the inspected matter 20′ is discharged onto conveyor 25 feeding the reclaimed pulp processing line. Otherwise, whenever an unacceptable batch is detected and therefore rejected, the computer unit causes an alarm to be set by the PLC before returning to the PLC monitoring mode. In operation, the computer unit 102 continuously sends a normal status signal in the form of a <<heart beat>> to the PLC through line 106′. The computer unit 102 also permanently monitors system operation in order to detect any software and/or hardware based error which could arise to command system interruption accordingly. Preferably, to save computer memory, the computer unit 102 does not keep all acquired images, so that after a predetermined period of time, images of acceptable inspected batches are deleted while images of rejected batches are recorded for later use. The image processing and communication module 118 performs system status monitoring functions related to automatic interruption conditions, communication with PLC and batch image data file management. These functions result in messages generation addressed to the operator through display 132 whenever appropriate action of the operator is required. For automatic interruption conditions, such a message may indicate that video image memory initialization failed, an illumination problem arose or a problem occurred with the camera 82 or the acquisition card. For PLC communication, the message may indicate a failure to establish communication with PLC 107, a faulty communication interruption, communication of a <<heart beat>> to the PLC 107, starting or interruption of the <<heart beat>>. As to batch data files management, the message may set forth that acquisition initialization failed, memory storing of image data failed, a file transfer error occurred, monitoring of batch files is being started or ended. Finally, general operation status information is given to the operator through messages indicating that the apparatus is ready to operate, acquisition has started, acquisition is in progress, image acquisition is completed and alarm for rejected batch occurred.

It is within the ambit of the present invention to cover any obvious modification of the described embodiment of the method and apparatus according to the present invention, provided it falls within the scope of the appended claims.

We claim:

1. A method for testing the quality of reclaimable waste paper matter containing contaminants, said method comprising the steps of:
i) directing polychromatic light onto an inspected area of said matter;
ii) sensing light reflected on the inspected matter to generate color image pixel data representing values of color components within a color space for pixels forming an image of said inspected area;
iii) comparing said image pixel data with color classification data related to at least one said contaminant to identify the pixels likely to be associated with the presence of said contaminant in said inspected area;
iv) selecting the remaining image pixel data likely to be not associated with said contaminant; and
v) generating luminance-related data from said remaining image pixel data to provide an indication of the quality of said reclaimable waste paper matter.

2. The method according to claim 1, further comprising between said steps iii) and iv), the step of:
a) analyzing the image pixel data by verifying if said identified pixels form one or more groups including a sufficient number of pixels to validate said pixels identification.

3. The method according to claim 1, further comprising the step of generating a histogram of identified pixel occurrences for said contaminant to provide an indication of the presence thereof in said inspected area.

4. The method according to claim 1, wherein said classification color data are derived from statistical distribution data representing values of color components within said color space that characterize said contaminant.

5. The method according to claim 4, wherein said classification color data is derived from said statistical distribution through Bayesian estimation of a probability that each said pixel be associated with the presence of said contaminant.

6. The method according to claim 5, wherein said estimated probability is greater than a predetermined probability threshold to be used to derive said classification color data.

7. The method according to claim 1, wherein said comparing step iii) included comparing said image pixel data with color classification data related to a plurality of said contaminants to identify the pixels likely to be associated with the presence of each said contaminant in said inspected area.

8. The method according to claim 7, further comprising the step of generating a histogram of identified pixel occurrences for each said contaminant to provide an indication of the presence thereof in said inspected area.

9. The method according to claim 7, wherein said classification color data are derived from a plurality of statistical distributions representing values of color components within said color space that characterize said plurality of contaminants

10. The method according to claim 9, wherein said classification color data is derived from said statistical distribution data through Bayesian estimation of a plurality of probability values that each said pixel be associated with the presence of said plurality of contaminants for selecting the statistical distribution having the highest probably value, to identify said pixel as to be likely associated with the presence of the contaminant characterized by said selected statistical distribution.

11. The method according to claim 10, wherein each said estimated probability value is greater than a predetermined probability threshold to be used to derive said classification color data.

12. An apparatus for testing the quality of reclaimable waste paper matter containing contaminants, said apparatus comprising:
a polychromatic light source for illuminating an inspected area of said matter;
an image sensor receiving light reflected on the inspected matter to generate color image pixel data representing values of color components within a color space for pixels forming an image of said inspected area;
data processor means for comparing said image pixel data with color classification data related to at least one said contaminant to identify the pixels likely to be associated with the presence of said contaminant in said inspected area, for selecting the remaining image pixel data likely to be not associated with said contaminant and for generating luminance-related data from said remaining image pixel data to provide an indication of the quality of said reclaimable waste paper matter.

13. The apparatus according to claim 12, wherein said data processor further analyzes the image pixel data by verifying if said identified pixels form one or more groups of pixels including a sufficient number of pixels to validate said pixels identification.

14. The apparatus according to claim 12, wherein said data processor further generates a histogram of identified pixel occurrences for said contaminant to provide an indication of the presence thereof in said inspected area.
